(19) United States
(12) Patent Application Publication
(10) Pub. No.: US 2013/0025196 A1
(43) Pub. Date: Jan. 31, 2013

(54) SYSTEM FOR DISPLAYING PLANTS

(71) Applicants: Steven Decker, New Preston, CT (US); Philip Feinman, Woodbury, CT (US)

(72) Inventors: Steven Decker, New Preston, CT (US); Philip Feinman, Woodbury, CT (US)

(21) Appl. No.: 13/194,811

(22) Filed: Jul. 29, 2011

(51) Int. Cl. A01G 1/00; A47G 29/00

(52) U.S. Cl. 47/39; 211/71.01; 211/49.1; 211/85.8

(57) ABSTRACT

The disclosed embodiments relate generally to a system for displaying plants. The system includes a tray and at least one grow pot with a protruding wick. Grow pots are easily and securely placed at an angle in the tray for display of foliage. The grow pots are easily rearranged and replaced without plant removal from the grow pot. Trays may be stacked together to provide a foliage area. Plants are easily watered by filling a tray to create a reservoir that conserves water. Individual grow pots need not be watered since the wicks take in water to the plant. Messy drainage of plants is avoided by the tray's ability to self-contain the water. Trays may be filled manually or with an automatic watering system. Slots or holes in the tray prevent over watering. Trays may be wall mounted or stacked in carriers. Carriers may have wheels for mobility, and a wheel cover for added appearance.

### FIELD OF THE INVENTION

A system for the display for foliage is disclosed herein and more particularly the disclosed system provides a novel tray and system to allow ease in placement and watering of plants.

### BACKGROUND OF THE INVENTION

Many of today's planters have self watering features in an attempt to conserve water. There has been a long felt need to save labor and time as well as grow healthier plants to extend life of the plants longer in the commercial and private sectors. In addition, there has been a need for self-watering systems of plants. Many products have been designed and built in an attempt to solve the problem of water conservation with varying success. Some systems supply a small continuous amount of water, often referred to as drip irrigation or trickle irrigation, while others rely on the moisture level in the soil to signal the need for water. Still others use surface tension and capillary action to bring water to the plant. All of these systems have draw backs and require messy drainage to some extent that takes away from the aesthetics of the foliage.

In the past, so called sub-irrigated plant containers provided water to plants from below by providing a supply of water, a means for refilling the supply, and means for drawing the water to the plant roots such as capillary action or vacuum based water emission. Prior plant displays that allow vertical display for greater visibility only allow watering one plant at a time. In automated watering systems, these vertical displays typically have the watering system prone to breakage and high maintenance. In addition these automated watering systems require the need to access to an electrical outlet and typically do not water evenly. In addition these prior systems utilize drainage systems that create additional issues.

It is previously known that there have been attempts to use devices to resolve these issue with little success. For example, U.S. Pat. No. 7,748,930, U.S. Pat. No. 7,712,253, and U.S. Pat. No. 7,198,431 all to Gesser that disclose a system for delivering a solution to plants through a microporous hydrophobic tubing. The tubing is positionable adjacent a root system of a plant. The tubing has a porosity adapted for permitting a flow of the solution when acted upon by water stress generated by the plant's root system. A pressure regulating device is upstream of the tubing's inlet, and a reservoir adapted for holding the solution is positioned with the pressure regulating device. A popular design element included in buildings is the so-called “Living Wall,” where plants are permitting to grow on a building wall. It has been estimated that one square meter of flowers can reduce the air exchange in a building by as much as 25 liters per second, thereby enabling a savings in energy usage via heating and air conditioning. This system has several drawbacks. First, it has a complex watering solution that adds time and effort to the users. In addition, this system lacks the ability to fully display the underlining foliage due to the complex watering solution. Second, the plants are individually watered and plants must be transplanted to re-design the foliage display.

Another attempt to resolve the above issues was seen in U.S. Pat. No. 5,446,995 to Huber. In this patent a portable modular drainage system is attached to a series of cylindrical planting container. When these modules are appropriately connected to the containers, they drain the water that would otherwise have fallen between the grow pots directly into the grow pots. The same drawback of the above devices affects this system. In this system plants are individually watered requiring time intense labor. In addition re-design of the foliage arrangement requires transplanting the plants.

In U.S. Pat. No. 7,832,147 to Weast a modular planter assembly is disclosed. This patent describes a modular planter assembly having a base housing with a cavity for dirt or growing material. Smaller elevated planters are supportable above the base planter on support members extending between a pair of vertically disposed elongated members. This assembly does not allow ease in displaying foliage. Any re-design of the foliage arrangement requires transplanting the plants. In addition, each individual plant needs to be water causing increased labor and time. The display also does not allow the foliage to be fully viewed.

Thus, there still remains in the art a need for a planter display that allows for watering of multiple plants at the same time and can be mounted in a manner to fully display the foliage on any vertical surface. There is also a need in the art for a display that allows water conservation and avoid messy drainage issues. A need also exists for a plant display that allows easy set-up and design of the foliage display without the need to transplant the foliage or involve additional time and labor.

### SUMMARY OF THE INVENTION

The present invention provides for the vertical display of plants. The display allows plant to be vertically displayed at an angle allowing full viewing of the foliage. In addition, the system of the present invention allows ease of watering so that individual plants do not have to be individually watered.

One of the intended purposes of the display system is to allow ease of setup and design of the plants. The original grow pots can be utilized in the invention thereby eliminating the need for further obtaining designer pots. The plants remain in their individual, original grow pots. Original grow pots are pots that are rarely used or seen as a decorative container. The original grow pots are used to initially grow the plant and deliver it to the customer. There is no need for transplanting the foliage when re-designing the foliage arrangement. The grow pots are simply placed in novel angular trays that have a common reservoir. Wicks at the bottom of the grow pots dip into the reservoir to feed the plants. Over-flow slots or holes may be provided to reduce overwatering the plants, especially in outdoor installations subject to rain fall. Drainage slots or holes are typically not needed for indoor installations. The angled tray makes it impossible to over water the plant. The angled portion of the tray is designed such that the height of the angular portion is lower than the air holes in the original growth pot of the plant. Root rot and disease is eliminated because air is always getting to the root of the plant. Drainage slots or holes are not required due to the design of the tray. Presence of the drainage slots or holes assist with drainage if present, but again not required. In addition, the plants are re-watered through filling the trays thereby reducing time and labor. Prior art wick and riser systems are replaced since a reservoir is created by the angle of the grow pot. The need for a riser is eliminated allowing better access to the reservoir and more space for the reservoir.

In one embodiment, the trays are mounted vertically on a wall. Any surface can be used for mounting the system. In addition carriers may be utilized instead of mounting on vertical surfaces. The carrier may include a mobility means such as wheels to move the display.

In another embodiment, the trays may be filled automatically by a pumping station to reduce labor on maintaining the plants. Drainage of the plant water is eliminated by having trays self contain the water and create a reservoir.

The foregoing objects are achieved and other features and advantages of the present invention will become more apparent in light of the following detailed description of exemplary embodiments thereof, as illustrated in the accompanying drawings.

### BRIEF DESCRIPTION OF THE DRAWINGS

In the drawings, wherein similar reference characters denote similar elements throughout the several views:

FIG. 1 shows a cross-sectional side view of one embodiment illustrating the plant display system.

FIG. 2 shows a view of one embodiment illustrating a tray.

FIG. 3 shows another embodiment perspective view illustrating a grow pot and wick.

FIG. 4 shows a front view of one embodiment of a carrier with trays.

FIG. 5 shows a side view of one embodiment of a carrier with trays with the carrier having a wheel cover.

FIG. 6 shows one embodiment of the plant display system mounted to a wall instead of in a carrier.

FIG. 7A shows a side cross-sectional view of one embodiment of a tray mounted to a wall.

FIG. 7B 6 shows the embodiment in FIG. 7A utilizing a different mounting system.

FIG. 8A shows a side cross-sectional view of one embodiment of a tray in a carrier.

FIG. 8B shows a perspective view of one embodiment of a tray in a carrier.

FIG. 9A shows a prior art wick and riser system.

FIG. 9B shows a prior art riser for the system in FIG. 9A.

### DETAILED DESCRIPTION

The invention will now be described in detail with reference to the accompanying drawings. The present invention relates to a plant display system. This system avoids the problems of the prior plant container systems of multiple water and transplanting of plants. An unexpected result of the present system is that it reduces root rot and disease of plants. By having the tray positioned at an angle, air is allowed to enter the roots, through exposed holes in the original grow pots, thereby minimizing root rot and disease. In addition, this system eliminates the need of a so-called “riser” in wick systems. A riser lifts the root system to create a water reservoir that allows the wick to intake the water to the plant. Risers typically cut off air supply to the underlying root system if the water goes slightly above the riser. By angling the plant and have the tray specifically designed so that the angle member resists overwatering, air is always permitted to the root system in the present invention.

This invention has the ability to redesign the foliage arrangement quickly by permitting each plant to remain in its original grow pot. Rearrangement is done simply by removing the grow pot from the tray and placing the grow pot in a different position. Setup is quicker than planting individual plants. The angular nature of the tray allows better visibility of the foliage. In addition the original grow pot is and the tray it self is covered by the foliage.

For purposes of this specification, foliage refers to all plant types, whether living or non-living, floral or non-floral, for commercial or private use. The use of the system is not limited to the type of plant used.

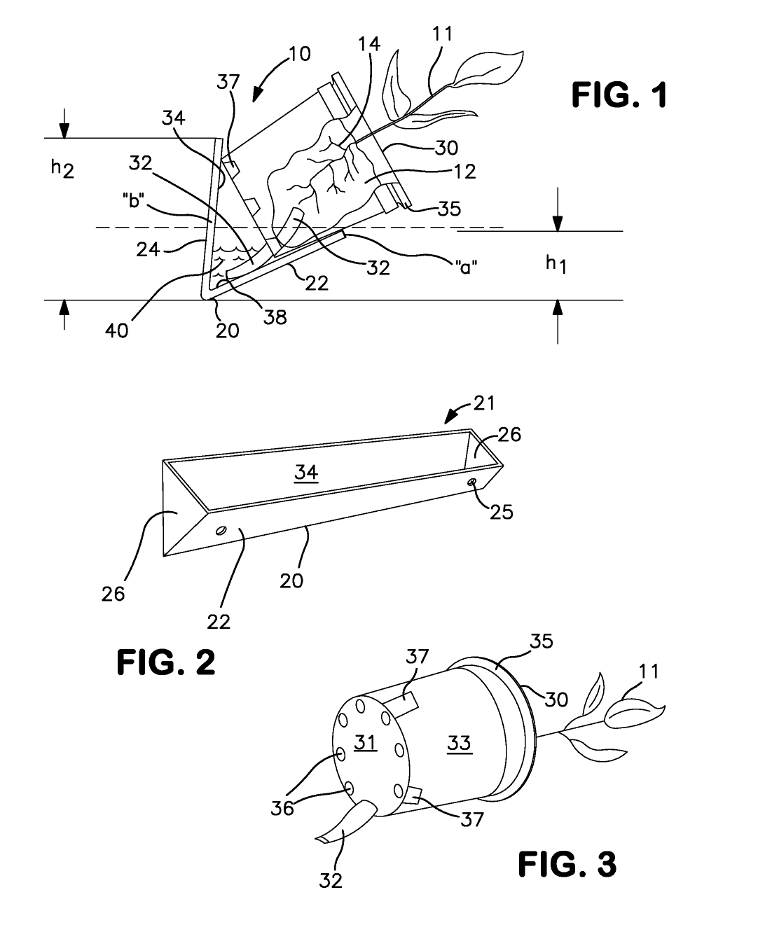

Adverting to the drawings, FIG. 1 illustrates one embodiment of the invention. As an example system 10 includes a grow pot 33 and an angular tray 21. Pot 33 is preferably a grow pot, but may be other types of containers depending on the embodiment. The advantage of having pot 33 a grow pot is that the plant never needs to be transplanted. The tray has a vertical portion 24 and an angular portion 22 connected at section 20. The angular portion 22 is designed such that over watering is prevented due to the shortness in height as compared to the tray's vertical portion 24. In addition the tray may have at least one hole or slots on angular portion 22 to prevent over watering. A reservoir 38 is created in the tray allowing multiple plants to be watered. The plants are feed through wick 32 protruding from the grow pot, although may be feed directly without a wick depending on the embodiment.

Further shown in FIG. 1 is Plane A-A. This plane defines the maximum water level allowed in the reservoir 38 for tray 21. The air holes or slots 36 and 37 of the grow pot are still exposed minimizing root rot and allowing the plant's roots to be exposed to air for furthering growth. For the purpose of this invention, the holes or slots may be limited to one or may be a plurality of holes or slots, depending on the embodiment. The slot or hole may be any size, shape or dimension to allow fluid to flow out of the tray. For example, the slot or hole may include, but is not limited to, being a shape that is round, oval, rectangular, square, or the like The slot or hole may be disposed on the angular portion 22 vertical portion 24, side portion or portions 26, or any combination thereof.

Plane A-A is a horizontal plane extending through an edge of angular portion 22 as denoted in FIG. 1 as point “a”. Plane A-A also extends through a point ‘b” disposed on the inner wall 34 of vertical portion 24. Vertical portion 24 and angular portion 22 form a reservoir 38 that may contain fluid 40. The fluid 40 may be, but is not limited to water, liquid fertilizer, plant growth material, or any combination thereof. Plane A-A is substantially parallel to the horizontal fluid level of fluid 40 when the tray is filled. Fluid enters pot 33 through one or more openings in the pot.

Shown in FIGS. 1 and 2 are openings 36 on the bottom of pot 33 and side openings 37 on the side of pot 33. These openings may be used in combination or individually depending on the embodiment. In addition, wick 32 may be utilized to assist in feeding the plant by disposing one end of the wick in fluid 40 and the other end of wick 32 in soil 12.

An unexpected result was found by having the tray dimensioned such that the vertical portion's length is shorter than the angular portion's length. Measured in the vertical direction, the height “h2” of the vertical portion is higher or longer than the vertical height “h1” of the angular portion. As a result, regardless of the fluid level of fluid 40, the fluid will never surpass Plane A-A because the fluid will exit at point “a.” What was surprisingly found as a result is that the roots 14 of plant 11 always has access to air from the bottom and/or sides of the pot. This continuous access to air due to the design of the tray prevents overwatering of the plant, minimizes root rot and promotes more healthier growth of the plant.

The tray may have multiple slots in the vertical portion. As an example FIG. 2 illustrates tray 21 with multiple holes 25, although not necessarily needs to accomplish the over watering protection ability of the display system. The holes can be anywhere on the front angle face or the sides or back of the tray depending on the embodiments. The hole can be any form or dimension, for example it may include, but not limited to slots, holes of any size or dimension and the like. The angular design of the tray allows full view of the foliage in grow pot 33.

In one embodiment, the grow pot 33 having opening 30 for plant 11 and a lip 35 is shown in FIG. 3 and has multiple air holes 36 and/or side air holes 34. Lip 35 of the grow pot allows secure placement of the grow pot in the tray, although not necessarily needs. There may be one or more plants in the pot depending on the embodiment. The tray securely positions the grow pot due to the specific angle created. Preferably the angle of the grow pot is about 45 degrees, but may be shown at between about 0 to 60 degrees depending on the embodiment.

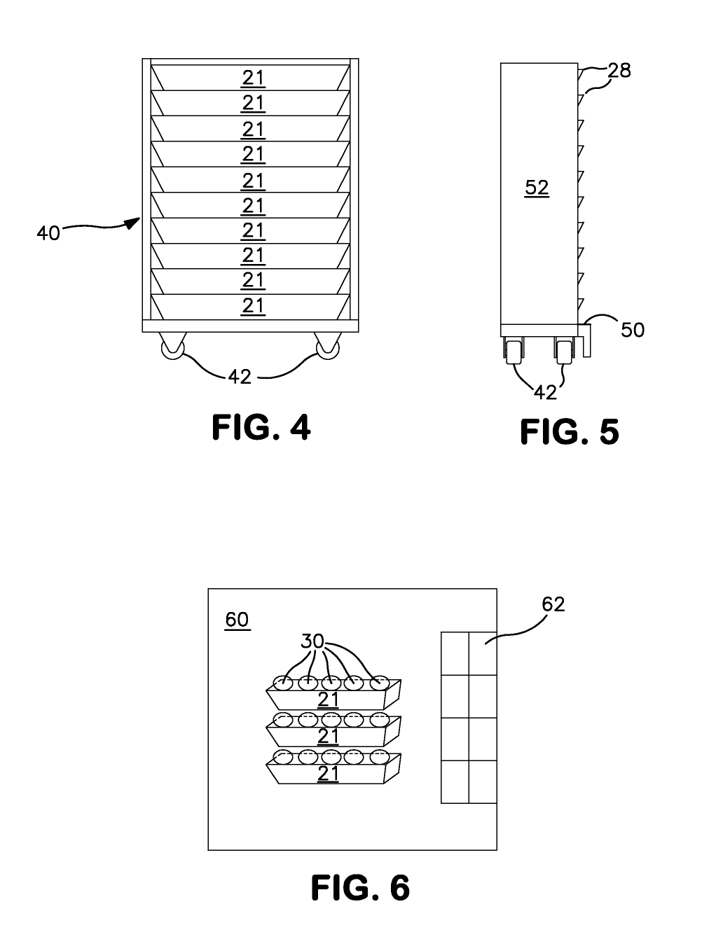

FIG. 4 illustrates one embodiment of a carrier. Trays 21 may be stacked vertically to accept grow pots and create a display. Wheels or other such devices may be utilized to make the carrier mobile thereby allowing movability of the display. The carrier may also be stationary and not contain any mobile means such as wheels and the like.

As shown in FIG. 5 illustrated is one embodiment where the carrier is mobile and contains a wheel cover 50 to add to the aesthetic look of the display. A plurality of side walls 52 may contain the trays securely in the carrier, although not necessarily so limited. Wheels 42 may or may not be used. The carrier may either be stationary or mobile. Other motion means may be used instead of wheels, including but not limited to, ball bearing, rolls, sliding material or the like.

FIG. 6 illustrates a vertical stacking of the system on a wall. The wall may be metal frames, fiberglass frames, drywall, brick or any surface and not limited to the material of the mounting surface. In this example, the system may be mounted near other structures such as window 62. Multiple trays may be stacked to create an area of foliage. The display system may be utilized indoors and outdoors.

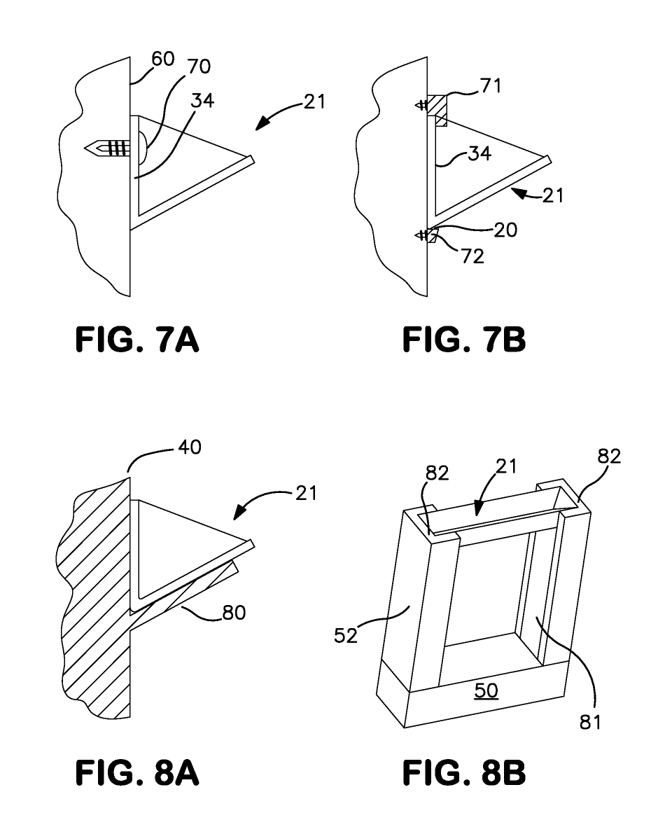

As shown in FIGS. 7A and 7B mounting can be done by several different means, although not so limited to the embodiments shown. In FIG. 7A, a mounting screw or bolt 70 is used to mount tray 21 to wall 60 through inner tray wall 34. The screw or bolt 70 may also be a nail, adhesive or other mounting means know in the art. In FIG. 7B, vertical channels are created by brackets 71 and 72. Again a mounting brackets may or may not be used depending on the embodiment. Depending on the embodiment, portion 20 of the tray may rest on the mounting bracket 72, and inner wall 34 may be secured by bracket 71.

FIGS. 8A and 8B the carrier may secure the tray by several means although not limited to the embodiments shown. FIG. 8A utilizes a angular member 80 in carrier 40 to hold tray 21. In FIG. 8B, tray 21 is held in vertical channel 81 formed by carrier side walls 52. Multiple trays may be stacked together in either embodiment to create an area of foliage. In one embodiment the trays may be positioned flat or horizontally to cover an area. In another embodiment the trays may be stacked to create a wall of foliage. The trays may be stacked vertically or at an angle such as, but not limited to staggered steps. In addition other configurations are possible for this tray, and the invention is not so limited to the embodiments discussed that are given as examples.

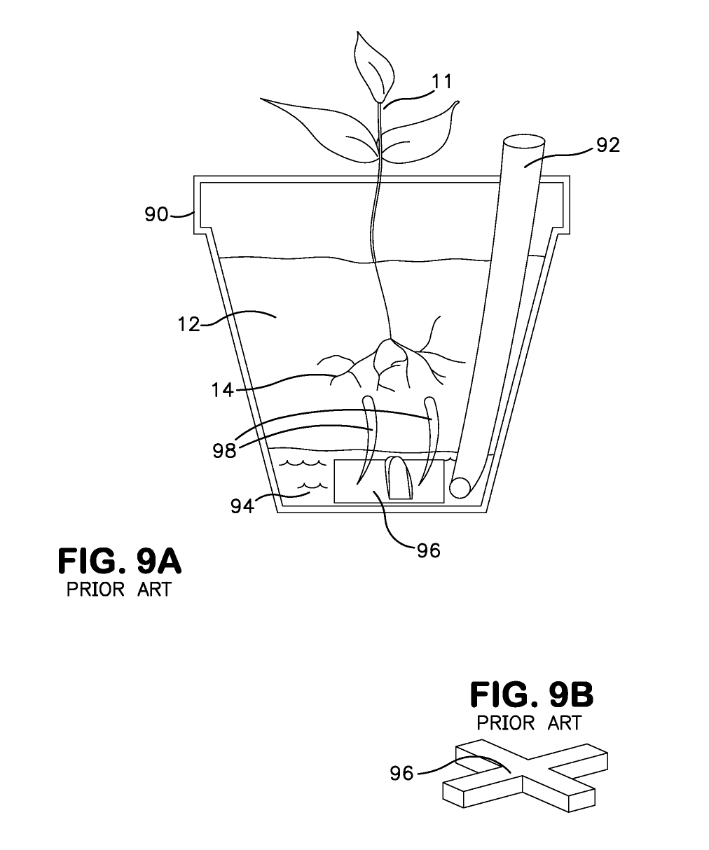

FIGS. 9A and 9B illustrate a prior art wick and riser system. As shown in FIG. 9A, riser 96 creates a reservoir 94 but takes up space of reservoir 94. In addition the roots 14 of the plant 11 do not have any air access below since the reservoir 94 blocks all the air holes in the bottom or sides of the plant 11 in pot 90. The soil 12 of plant 11 is still unable to obtain air from the bottom of the plant to get air to roots 14. In addition a filling tube 92 is needed in this system that only allows watering of one plant at a time. The wicks 98 pull water to roots 11, but are obstructed by riser 96 giving less than optimal watering to the roots. In addition, the riser takes away space that could be utilized for holding fluid in the reservoir. Such a prior art system is prone to overwatering, root rot, and unhealthy growth of the plant. FIG. 9B illustrates one prior art riser utilized in the system in FIG. 9A. Other configurations of a riser are know in the art. The use of a riser is eliminated with the current invention, and thereby removes the draw backs of using a riser, and other drawbacks noted above.

Other alternative embodiments or implementations according to the various teachings of the present invention will be understood by those skilled in the art and are achieved without departing from the spirit and scope of the invention. It is therefore intended that the present invention is not limited to the disclosed embodiments described herein but should be defined in accordance with the claims that follow.

We claim:

1. A system for displaying plants, comprising:
a tray having a vertical portion, an angular portion and at least one side portion for displaying at least one plant in a grow pot.

2. The system of claim 1, further including a reservoir portion disposed in the tray for watering roots of the at least one plant.

3. The system of claim 1, wherein the tray further defines at least one slot or hole for preventing over watering of the plant.

4. The system of claim 3, wherein the at least one slot or hole is defined by the vertical portion or side portion of the tray.

5. The system of claim 1 wherein the angular portion and the vertical portion define a horizontal plane and the angular portion is longer in overall length than the vertical portion of the tray for preventing overwatering of the plant and allowing air to access roots of the plant.

6. The system of claim 1, wherein the tray is a plurality of trays positioned together for allowing coverage of an area of foliage.

7. The system of claim 6, wherein the trays are stacked in a vertical manner.

8. The system of claim 6, wherein the trays are mounted on a wall or carrier.

9. The system of claim 8, wherein the carrier is mobile

10. The system of claim 8, wherein the carrier is stationary.

11. A system for displaying plants, comprising:
at least one tray having a vertical portion, an angular portion, and a reservoir portion configured to receive at least one pot, and
a holder to provide support for the tray.

12. The system of claim 11, wherein the reservoir portion is supplied by an automated water supply.

13. The system of claim 11, wherein the holder is a carrier or a mounting device.

14. The system of claim 13, wherein the carrier includes wheels and a wheel cover.

15. The system of claim 13, wherein the mounting device forms vertical or horizontal channels for mounting on a vertical surface.

16. A system for displaying plants, comprising:
a plurality of trays stacked vertically, each tray having a vertical portion, an angular portion, side portions, and a reservoir portion for holding fluid; the trays designed with an angular flat surface such that any shape grow pot or pots are securely disposed within the tray;
the grow pot or pots are disposed in the tray at an angle for displaying foliage such that air is accessible to the bottom of the grow pot or pots regardless of fluid level in the reservoir portion; and
a holder that is in contact with the tray to provide support for the tray.

17. The system of claim 16, wherein the vertical portion further defines at least one slot or hole to prevent over-watering.

18. The system of claim 16, wherein the holder is a stationary or a mobile carrier.

19. The system of claim 16, wherein the holder is a mounting bracket for mounting the trays on a vertical surface.

20. The system of claim 16, wherein the overall length dimension of the angular portion is longer in length than the overall length dimension of the vertical portion.

21. The system of claim 16, wherein the reservoir for each tray is filled with an ordinary hose or automated watering system.

22. The system of claim 16, wherein the holder further includes an angular arm for supporting the tray.

23. A system for displaying plants, comprising:
a tray having a vertical portion and an angular portion, the vertical portion dimensioned such that the length of the vertical portion is shorter than the length of the angular portion and the vertical height of the vertical portion is higher than the vertical height of the angular portion, the tray being shaped to hold any pot therein;
a reservoir for holding fluid, and defined by the vertical portion and angular portion,
a horizontal plane defined by an edge of the angular portion, the horizontal plane being substantially parallel to fluid level in the reservoir, and
wherein, air is in communication with a bottom of the pot regardless of fluid level in the reservoir.

24. The system of claim 23, wherein the pot's bottom defines at least one slot or hole and the air minimizes occurrence of root rot.

25. The system of claim 23, wherein the pot's bottom defines at least one slot or hole and the air promotes growth of at least one plant in the pot.

26. The system of claim 23, wherein the pot is a growth pot.

27. The system of claim 23, wherein air is also in communication with at least one side of the pot regardless of fluid level in the reservoir.

28. The system of claim 27, wherein the pot's side defines at least one slot or hole and the air minimizes occurrence of root rot.

29. The system of claim 27, wherein the pot's side defines at least one slot or hole and the air promotes growth of at least one plant in the pot.

30. The system of claim 23, wherein the pot's bottom and side define at least one slot or hole.
